(19) United States
(12) Patent Application Publication
(10) Pub. No.: US 2015/0210587 A1
(43) Pub. Date: Jul. 30, 2015

(54) METHOD OF FORMING A COATED GLASS SUBSTRATE

(71) Applicant: PPG Industries Ohio, Inc., Cleveland, OH (US)

(72) Inventors: Renlong Gao, Allison Park, PA (US); Kurt A. Humbert, Pittsburgh, PA (US)

(73) Assignee: PPG Industries Ohio, Inc., Cleveland, OH (US)

(21) Appl. No.: 14/164,708

(22) Filed: Jan. 27, 2014

(51) Int. Cl. C03C 17/30

(52) U.S. Cl. CPC C03C 17/30; C03C 2217/00; C03C 2218/13; C03C 2218/32

(57) ABSTRACT

A method of forming a coated glass substrate is described, which involves: (a) applying a first composition that includes a hydrolysable silane to a surface of a glass substrate, thereby forming a treated surface of the glass substrate; (b) applying to the treated surface a second composition that includes a fluorinated polyether modified silane, thereby forming an intermediate coated glass substrate; and (c) subjecting the intermediate coated glass substrate to elevated temperature, thereby curing the second composition and forming the coated glass substrate. The method of the present invention results in the formation, with some embodiments, of coated glass substrates that possess anti-fouling properties.

### FIELD

The present invention relates to a method of forming a coated glass substrate that involves applying a first composition that includes a hydrolysable silane to a surface of a glass substrate so as to form a treated glass substrate, applying to the treated surface a second composition that includes a fluorinated polyether modified silane, so as to form an intermediate coated glass substrate, which is then subjected to elevated temperature, so as to cure the second composition and thereby form the coated glass substrate.

### BACKGROUND

Glass surfaces, such as on electronic or digital displays, such as on smart phones, computer tablets, and control panel touch screens, are susceptible to the pick-up of dirt and/or oil, such as from contact with human skin, such as human fingertips. The pick-up of dirt and/or oil on a glass surface can inhibit seeing through the glass layer, such as visually viewing an electronic display on the other side of the glass layer. Fluorinated organic compounds are capable of providing low surface tension, which can minimize the pick-up of dirt and/or oil on a surface, in some circumstances. It can be difficult, in some instances, to form a film having a desirable level of continuity and smoothness using fluorinated organic compounds. In addition, films formed from fluorinated organic compounds can have an undesirable level of durability, in particular with regard to a reduction in dirt and/or oil pick-up resistance after exposure to repetitive abrasion resulting from use over a period of time.

It would be desirable to develop new methods of coating glass substrates that result in the formation of coated glass substrates that have a desirable level of dirt and/or oil pick-up resistance. It would be further desirable that such newly developed methods provide coated glass substrates that have improved durability with regard to retaining a desirable level of dirt and/or oil pick-up resistance over time.

### SUMMARY

In accordance with the present invention, there is provided a method of forming a coated glass substrate that comprises, (a) applying a first composition comprising a hydrolysable silane to a surface of a glass substrate, thereby forming a treated surface of said glass substrate, wherein said hydrolysable silane is represented by the following Formula (I),

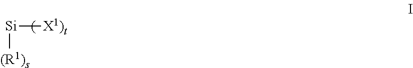

wherein,
R¹ independently for each s is hydrocarbyl,
X¹ Independently for each t is a hydrolysable group, and
s is from 0 to 3, t is from 1 to 3, t is from 1 to 4, provided that the sum of s and t is 4, and provided that t is at least 1. The method of the present invention further comprises, (b) applying, to the treated surface, formed in step (a), a second composition comprising a fluorinated polyether modified silane, thereby forming an intermediate coated glass substrate. The method of the present invention additionally comprises, (c) subjecting the intermediate coated glass substrate, formed in step (b), to elevated temperature, thereby curing the second composition (or concurrently curing the first composition and the second composition) and forming the coated glass substrate.

In accordance with the present invention, there is further provided a coated glass substrate that is formed by the above method.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### DETAILED DESCRIPTION

As used herein, the articles “a,” “an,” and “the” include plural referents unless otherwise expressly and unequivocally limited to one referent

Unless otherwise indicated, all ranges or ratios disclosed herein are to be understood to encompass any and all subranges or subratios subsumed therein. For example, a stated range or ratio of “1 to 10” should be considered to include any and all subranges between (and inclusive of) the minimum value of 1 and the maximum value of 10; that is, all subranges or subratios beginning with a minimum value of 1 or more and ending with a maximum value of 10 or less, such as but not limited to, 1 to 6.1, 3.5 to 7.8, and 5.5 to 10.

As used herein, unless otherwise indicated, left-to-right representations of linking groups, such as divalent linking groups, are inclusive of other appropriate orientations, such as, but not limited to, right-to-left orientations. For purposes of non-limiting illustration, the left-to-right representation of the divalent linking group

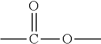

or equivalently —C(O)O—, is inclusive of the right-to-left representation thereof,

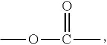

or equivalently —O(O)C— or —OC(O)—.

As used herein, the term “oxirane” and related terms, such as “oxirane group(s)” means a group represented by the following formula:

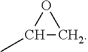

As used herein, the term “thiooxirane” and related terms, such as “thiooxirane group(s)” means a group represented by the following formula:

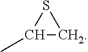

As used herein, the term “glycidoxy” and related terms, such as “glycidyl” means a group represented by the following formula:

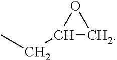

As used herein, the term “thioglycidoxy” and related terms, such as “thioglycidyl” means a group represented by the following formula:

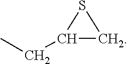

Other than in the operating examples, or where otherwise indicated, all numbers expressing quantities of ingredients, reaction conditions, and so forth used in the specification and claims are to be understood as modified in all instances by the term “about”.

As used herein, molecular weight values of polymers, such as weight average molecular weights (Mw) and number average molecular weights (Mn), are determined by gel permeation chromatography using appropriate standards, such as polystyrene standards.

As used herein, polydispersity index (PDI) values represent a ratio of the weight average molecular weight (Mw) to the number average molecular weight (Mn) of the polymer (i.e., Mw/Mn).

As used herein, the term “polymer” means homopolymers (e.g., prepared from a single monomer species), copolymers (e.g., prepared from at least two monomer species), and graft polymers.

As used herein, spatial or directional terms, such as “left”, “right”, “inner”, “outer”, “above”, “below”, and the like, relate to the invention as it is depicted in the drawing figures. It is to be understood, however, that the invention can assume various alternative orientations and, accordingly, such terms are not to be considered as limiting.

All documents, such as but not limited to issued patents and patent applications, referred to herein, and unless otherwise indicated, are to be considered to be “incorporated by reference” in their entirety.

As used herein, recitations of “linear or branched” groups, such as linear or branched alkyl, are herein understood to include: a methylene group or a methyl group; groups that are linear, such as linear C₂-C₂₅ alkyl groups; and groups that are appropriately branched, such as branched C₃-C₂₅ alkyl groups.

The various components and compounds of the compositions, such as, but not limited to the first and second compositions, of the method of the present invention, independently include hydrocarbyl groups and/or substituted hydrocarbyl groups. As used herein the term “hydrocarbyl” and similar terms, such as “hydrocarbyl substituent” and “hydrocarbyl group” means: linear or branched C₁-C₂₅ alkyl (e.g., linear or branched C₁-C₁₀ alkyl, or linear or branched C₁-C₆ alkyl); linear or branched C₂-C₂₅ alkenyl (e.g., linear or branched C₂-C₁₀ alkenyl); linear or branched C₂-C₂₅ alkynyl (e.g., linear or branched C₂-C₁₀ alkynyl); C₃-C₁₂ cycloalkyl (e.g., C₃-C₁₀ cycloalkyl, or C₃-C₆ cycloalkyl); C₃-C₁₂ heterocycloalkyl (having at least one hetero atom in the cyclic ring); C₅-C₁₈ aryl (including polycyclic aryl groups) (e.g., C₅-C₁₀ aryl); C₅-C₁₈ heteroaryl (having at least one hetero atom in the aromatic ring); and C₆-C₂₄ aralkyl (e.g., C₆-C₁₀ aralkyl).

Representative alkyl groups include but are not limited to methyl, ethyl, propyl, isopropyl, butyl, isobutyl, sec-butyl, tert-butyl, pentyl, neopentyl, hexyl, heptyl, octyl, nonyl and decyl. Representative alkenyl groups include but are not limited to vinyl, allyl and propenyl. Representative alkynyl groups include but are not limited to ethynyl, propynyl, 1-butynyl, and 2-butynyl. Representative cycloalkyl groups include but are not limited to cyclopropyl, cyclobutyl, cyclopentyl, cyclohexyl, and cyclooctyl groups. Representative heterocycloalkyl groups include but are not limited to imidazolyl, tetrahydrofuranyl, tetrahydropyranyl, morpholinyl, and piperidinyl. Representative aryl groups include but are not limited to phenyl, naphthyl, anthracenyl and triptycenyl. Representative heteroaryl groups include but are not limited to furanyl, pyranyl, pyridinyl, isoquinoline, and pyrimidinyl. Representative aralkyl groups include but are not limited to benzyl, and phenethyl.

The term “alkyl” as used herein, in accordance with some embodiments, means linear or branched alkyl, such as but not limited to, linear or branched C₁-C₂₅ alkyl, or linear or branched C₁-C₁₀ alkyl, or linear or branched C₂-C₁₀ alkyl, or linear or branched C₁-C₆ alkyl. Examples of alkyl groups from which the various alkyl groups of the present invention can be selected from, include, but are not limited to, those recited previously herein. Alkyl groups of the various compounds and components of the method of the present invention can, with some embodiments, include one or more unsaturated linkages selected from —CH═CH— groups and/or one or more —C≡C— groups, provided that the alkyl group is not aromatic. With some embodiments, the alkyl group is free of two or more conjugated unsaturated linkages. With some embodiments, the alkyl groups are free of unsaturated linkages, such as —CH═CH— groups and —C≡C— groups.

The term “cycloalkl” as used herein, in accordance with some embodiments, means groups that are appropriately cyclic, such as but not limited to, C₃-C₁₂ cycloalkyl (including, but not limited to, cyclic C₅-C₇ alkyl) groups. Examples of cycloalkyl groups include, but are not limited to, those recited previously herein. The term “cycloalkyl” as used herein in accordance with some embodiments also includes: bridged ring polycycloalkyl groups (or bridged ring polycyclic alkyl groups), such as but not limited to, bicyclo[2.2.1]heptyl (or norbornyl) and bicyclo[2.2.2]octyl; and fused ring polycycloalkyl groups (or fused ring polycyclic alkyl groups), such as, but not limited to, octahydro-1H-indenyl, and decahydronaphthalenyl.

The term “heterocycloalkyl” as used herein, in accordance with some embodiments, means groups that are appropriately cyclic, such as but not limited to, C₃-C₁₂ heterocycloalkyl groups or C₅-C₇ heterocycloalkyl groups, and which have at least one hetero atom in the cyclic ring, such as, but not limited to, O, S, N, P, and combinations thereof. Examples of heterocycloalkyl groups include, but are not limited to, those recited previously herein. The term “heterocycloalkyl” as used herein, in accordance with some embodiments, also includes: bridged ring polycyclic heterocycloalkyl groups, such as but not limited to, 7-oxabicyclo[2.2.1]heptanyl; and fused ring polycyclic heterocycloalkyl groups, such as but not limited to, octahydrocyclopenta[b]pyranyl, and octahydro-1H-isochromenyl.

The term “heteroaryl,” as used herein, in accordance with some embodiments, includes but is not limited to C₅-C₁₈ heteroaryl, such as but not limited to C₅-C₁₀ heteroaryl (including fused ring polycyclic heteroaryl groups) and means an aryl group having at least one hetero atom in the aromatic ring, or in at least one aromatic ring in the case of a fused ring polycyclic heteroaryl group. Examples of heteroaryl groups include, but are not limited to, those recited previously herein.

The term “aralkyl,” as used herein, and in accordance with some embodiments, includes but is not limited to C₆-C₂₄ aralkyl, such as but not limited to C₆-C₁₀ aralkyl, and means an aryl group substituted with an alkyl group. Examples of aralkyl groups include, but are not limited to, those recited previously herein.

As used herein, the term “optionally interrupted with at least one —O— group” with regard to the various divalent linking groups of the components and compounds of the method of the present invention means that at least one carbon of, but less than all of the carbons of, the divalent linking group (such as, but not limited to, a divalent hydrocarbyl group) is in each case independently replaced with the recited divalent non-carbon linking group, —O—. The divalent linking groups can be interrupted with two or more —O— groups, which can be adjacent to each other or separated by one or more carbons. Examples of adjacent —O— groups include, but are not limited to, divalent peroxide groups, —O—O—. With some embodiments, the divalent linking groups which are interrupted with at least one of —O— group are free of two or more adjacent divalent oxygen groups —O—.

As used herein, recitations of ‘optionally substituted’ group, means a group, including but not limited to, alkyl group, cycloalkyl group, heterocycloalkyl group, aryl group, and/or heteroaryl group, in which at least one hydrogen thereof has been optionally replaced or substituted with a group that is other than hydrogen, such as, but not limited to, halo groups (e.g., F, Cl, I, and Br), hydroxyl groups, ether groups, thiol groups, thio ether groups, carboxylic acid groups, carboxylic acid ester groups, phosphoric acid groups, phosphoric acid ester groups, sulfonic acid groups, sulfonic acid ester groups, nitro groups, cyano groups, hydrocarbyl groups (including, but not limited to: alkyl; alkenyl; alkynyl; cycloalkyl, including poly-fused-ring cycloalkyl and polycyclocalkyl; heterocycloalkyl; aryl, including hydroxyl substituted aryl, such as phenol, and including poly-fused-ring aryl; heteroaryl, including poly-fused-ring heteroaryl; and aralkyl groups), and amine groups, such as —N(R₁₁′)(R₁₂′) where R₁₁′ and R₁₂′ are each independently selected, with some embodiments, from hydrogen, linear or branched C₁-C₂₀ alkyl, C₃-C₁₂ cycloakyl, C₃-C₁₂ heterocycloalkyl, aryl, and heteroaryl.

As used herein, the term “fluorinated” and related terms, such as “fluoro-substituted” such as with regard to “fluorinated groups” such as, but not limited to, “fluorinated hydrocarbyl group(s)” and “fluorinated divalent hydrocarbyl group(s)” and further related terms (such as, but not limited to, fluoroalkyl groups, fluoroalkenyl groups, fluoroalkynyl groups, fluoroaryl groups and fluoro-heteroaryl groups) means a group in which at least one available hydrogen thereof, and up to and including all of the available hydrogens thereof, is substituted with a fluorine group (or atom). The term “fluorinated” and related terms, such as “fluoro-substituted” is inclusive of “perfluorinated” and related terms, such as “perfluoro-substituted.”

As used herein, the term “perfluoro” and related terms, such as “perfluorinated” such as with regard to “perfluoro groups” such as, but not limited to, “perfluorohydrocarbyl groups” and “perfluoro divalent hydrocarbyl groups” and further related terms (such as, but not limited to perfluoroalkyl groups, perfluoroalkenyl groups, perfluoroalkynyl groups, perfluoroaryl groups and perfluoro-heteroaryl groups) means a group in which all of the available hydrogens thereof are substituted with a fluorine group (or atom). For purposes of non-limiting illustration, perfluoromethyl is —CF₃, and perfluorophenyl is —C₅F₅.

The method of the present invention includes applying a first composition to a surface of a glass substrate. The glass substrate can, with some embodiments, be selected from known glass substrates. With some embodiments, the glass substrate is selected from conventional soda-lime-silicate glass, borosilicate glass, and/or leaded glass. The glass substrate can be clear glass. By “clear glass” is meant non-tinted or non-colored glass. Alternatively, the glass substrate can be tinted or otherwise colored glass. The glass can be annealed or heat-treated glass. As used herein, the term “heat treated” means tempered, bent, heat strengthened, laminated, or chemical treated during the annealing process. The glass can be of any type, such as conventional float glass, and can be of any composition having any optical properties, such as any value of visible transmission, ultraviolet transmission, infrared transmission, and/or total solar energy transmission. The transparent substrate can be selected from, for example, clear float glass or can be tinted or colored glass.

The glass substrate can be of any desired dimensions, such as length, width, shape, and/or thickness. With some embodiments, the glass substrate can be greater than 0 up to 10 mm thick, such as 1 mm to 10 mm thick, or 1 mm to 5 mm thick, or less than 4 mm thick, such as, 3 mm to 3.5 mm thick, or 3.2 mm thick. Additionally, the glass substrate can be of any desired shape, such as flat, curved, parabolic-shaped, or the like, with some embodiments.

With some embodiments, the glass substrate can have a high visible light transmission at a reference wavelength of 550 nanometers (nm) and a reference thickness of 3.2 mm. By “high visible light transmission” is meant visible light transmission at 550 nm of greater than or equal to 85%, such as greater than or equal to 87%, such as greater than or equal to 90%, such as greater than or equal to 91%, such as greater than or equal to 92%, such as greater than or equal to 93%, such as greater than or equal to 95%, at 3.2 mm reference thickness for the transparent substrate. Further non-limiting examples of glass from which the glass substrate can be selected include, but are not limited to, those disclosed in U.S. Pat. Nos. 5,030,593 and 5,030,594. Non-limiting examples of glass from which the glass substrate can be selected include, but are not limited to, Starphire®, Solarphire®, Solarphire® PV, Solargreen®, Solextra®GL-20®, GL-35™, Solarbronze®, CLEAR, and Solargray® glass, all commercially available from PPG Industries Inc. of Pittsburgh, Pa.

With some embodiments, the glass substrate is selected from one or more strengthened glass substrates, such as chemically strengthened glass substrates. The glass substrate, with some embodiments, is selected from chemically strengthened glass substrates that have been subjected to art-recognized ion-exchange processes, in which smaller sodium ions at or near the surface of the glass have been exchanged with larger ions, such as potassium ions. The on-exchange process can, with some embodiments, be conducted in accordance with art-recognized methods, which involve placing a glass specimen in a heated molten salt bath at a temperature of 400° C., which results in sodium ions at or near the surface of the glass specimen being replaced with larger ions, such as potassium ions, that are present in the molten salt bath. The ion-exchange process results in the formation of a layer of compressive stress at the surface of the treated glass, which increases the strength of the glass. Examples of strengthened glass substrates, such as chemically strengthened glass substrates, from which the glass substrates of the methods of the present invention can be selected, include, but are not limited to, GORILLA glass products, which are commercially available form Corning Incorporated.

The method of the present invention includes applying a first composition to a surface of a glass substrate, so as to form a treated surface of the glass substrate, and then applying a second composition to the treated surface of the glass substrate. As used herein, “to a surface of a glass substrate” means the first composition is applied to at least a portion of a surface of the glass substrate, such as greater than 0 percent of the surface area up to and including 100 percent of the surface area, in each case of a surface of the glass substrate. As used herein, “applying to said treated surface” means that the second composition is applied to at least a portion of the treated surface, such as greater than 0 percent of the surface area up to and including 100 percent of the surface area, in each case of the treated surface.

The method of the present invention includes applying, to the surface of a glass substrate, a first composition that includes a hydrolysable silane represented by Formula (I) above. With further reference to Formula (I), and in accordance with some embodiments, X¹ of Formula (I) is represented by the following Formula (II),

—O—R² (II)

With reference to Formula (II), R² independently for each t is hydrocarbyl.

With further reference to Formulas (I) and (II), and in accordance with some embodiments: R¹ independently for each s is selected from aryl, C₃-C₈ cycloalkyl, and linear or branched C₁-C₂₀ alkyl; and R² independently for each t is selected from aryl, C₃-C₈ cycloalkyl, and linear or branched C₁-C₂₀ alkyl.

In accordance with some embodiments, and with further reference to Formulas (I) and (II): R¹ independently for each s is linear or branched C₁-C₆ alkyl; R² independently for each t is linear or branched C₁-C₆ alkyl; and the sum of s and t is 4, provided that t is at least 3. Examples of linear or branched C₁-C₆ alkyl groups from which R¹ and R² can each independently be selected, with some embodiments, include, methyl, ethyl, n-propyl, branched structural isomers of propyl, n-butyl, branched structural isomers of butyl, n-pentyl, branched structural isomers of pentyl, n-hexyl, and branched structural isomers of hexyl.

With further reference to Formulas (I) and (II), and in accordance with some embodiments, subscript t is 4, and correspondingly s is 0 (zero). With some embodiments, the hydrolysable silane, represented by Formula (I), of the first composition, is selected from one or more tetraalkoxy silanes, such as tetra(linear or branched C₁-C₆ alkoxy)silanes, such as tetraethoxysilane and/or tetramethoxysilane.

The first composition of the method of the present invention, with some embodiments, is free of solvent. With some further embodiments, the first composition includes one or more solvents, such as one or more organic solvents. The solvent can, with some embodiments, be present in any suitable amount. With some embodiments, the solvent is present in an amount of at least 95 percent by weight, or at least 96 percent by weight and less than or equal to 99.99 percent by weight, or less than or equal to 98 percent by weight, the percent weights being based on total weight of the first composition. The solvent can be present in the first composition in an amount ranging between any combination of these upper and lower values, such as from 95 to 99.99 percent by weight, or from 96 to 98 percent by weight, based on the total weight of the first composition.

With some embodiments, the first composition of the method of the present invention further includes an organic solvent. The organic solvent, with some further embodiments, includes at least one of: linear or branched alkanes; cycloalkanes; aromatic compounds; alcohols; ethers; aldehydes; ketones; and/or carboxylic acid esters. The organic solvent, with some embodiments, is selected from those organic solvents that are liquid under ambient conditions, such as at standard temperature and pressure (STP). The linear or branched alkanes, from which the organic solvent can be selected, include, but are not limited to, linear or branched C₅-C₂₅ alkanes, or linear or branched C₅-C₁₀ alkanes, or linear or branched C₅-C₁₀ alkanes, with some embodiments. The cycloalkanes, from which the organic solvent can be selected, include, but are not limited to, C₅-C₁₂ cycloalkanes, or C₅-C₁₀ cycloalkanes, with some embodiments. The cycloalkanes, from which the organic solvent can be selected, also include: bridged ring polycycloalkanes (or bridged ring polycyclic alkane groups), such as but not limited to, bicyclo[2.2.1]heptane (or norbornane) and bicyclo[2.2.2]octane; and fused ring polycycloalkanes (or fused ring polycyclic alkanes), such as, but not limited to, octahydro-1H-indenane, and decahydronaphthalene. The aromatic compounds, from which the organic solvent can be selected, include, but are not limited to: C₅-C₁₈ aromatic compounds (including polycyclic aromatic compounds) (such as, C₅-C₁₀ aromatic compounds), including hydrocarbyl substituted aromatic compounds; and C₅-C₁₈ heteroaromatic compounds (having at least one hetero atom in the aromatic ring), including hydrocarbyl substituted heteroaromatic compounds, with some embodiments.

Alcohols from which the organic solvent of the first composition can be selected, include, but are not limited to, hydrocarbyl alcohols having one or more hydroxyl groups, in which the hydrocarbyl is selected from those classes and examples as recited previously herein. Ethers from which the organic solvent of the first composition can be selected, include, but are not limited to, hydrocarbyl-hydrocarbyl ethers, in which each hydrocarbyl group is independently selected from those classes and examples as recited previously herein. Aldehydes from which the organic solvent of the first composition can be selected, include, but are not limited to, hydrocarbyl aldehydes, in which the hydrocarbyl is selected from those classes and examples as recited previously herein. Ketones from which the organic solvent of the first composition can be selected, include, but are not limited to, hydrocarbyl-hydrocarbyl ketones, in which each hydrocarbyl group is independently selected from those classes and examples as recited previously herein. Carboxylic acid esters from which the organic solvent of the first composition can be selected, include, but are not limited to, those represented by the following Formula (XV).

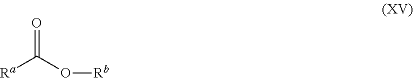

With reference to Formula (XV), Ra and Rb are each independently a hydrocarbyl group, which can each independently be selected from those classes and examples of hydrocarbyl groups recited previously herein.

In accordance with some embodiments, the organic solvent of the first composition includes at least one linear or branched C₁-C₆ alcohol Examples of linear or branched C₁-C₆ alcohols from which the organic solvent of the first composition can be selected, include, but are not limited to, methanol, ethanol, n-propanol, iso-propanol, n-butanol, branched structural isomers of butanol, n-petanol, branched structural isomers of pentanol, n-hexanol, and/or branched structural isomers of hexanol.

The hydrolysable silane can be present in the first composition of the method of the present invention in any suitable amount. With some embodiments, the hydrolysable silane is present in the first composition in an amount of at least 0.01 percent by weight, or at least 2 percent by weight; and less than or equal to 5 percent by weight, or less than or equal to 4 percent by weight, the percent weights being based on total weight of the first composition. The hydrolysable silane can be present in the first composition in an amount ranging between any combination of these upper and lower values, inclusive of the cited values, such as from 0.01 to 5 percent by weight, or from 2 to 4 percent by weight, based on total weight of the first composition, with some embodiments.

The first composition of the method of the present invention, with some embodiments, includes a protonic acid. The protonic acid, with some embodiments, acts as a catalyst, which catalyzes condensation of the hydrolysable groups of the hydrolysable silane.

With some embodiments, the protonic acid of the first composition includes at least one of, carboxylic acid, hydrogen halide, sulphuric acid, and/or nitric acid.

Carboxylic acids from which the protonic acid can be selected, with some embodiments, include, but are not limited to, hydrocarbyl groups having at least one carboxylic acid group, in which the hydrocarbyl group is selected from those classes and examples recited previously herein. Examples of carboxylic acids, from which the protonic acid can be selected, with some embodiments, include, but are not limited to, linear or branched C₁-C₆ carboxylic acids, such as acetic acid. Examples of hydrogen halides from which the protonic acid of the first composition can be selected from include, but are not limited to, HCl, HF, HBr, and/or HI.

The protonic acid can be present in the first composition in any suitable amount, such as a catalytic amount, with some embodiments. The protonic acid, with some embodiments, is present in the first composition in an amount of from 0.01 to 5 parts by weight per 100 parts by weight of the hydrolysable silane.

In accordance with some embodiments of the method of the present invention, the first composition further includes a functional hydrolysable silane. The functional hydrolysable silane is different from the hydrolysable silane of the first composition, which is represented by Formula (I), as described previously herein. The functional hydrolysable silane of the first composition, with some embodiments, is represented by the following Formula (III),

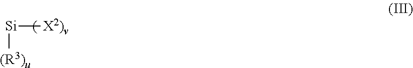

With reference to Formula (III), R³ independently for each u is hydrocarbyl (that is free of functional groups), or hydrocarbyl having at least one functional group selected from hydroxyl, thiol, primary amine, secondary amine, oxirane, and thiooxirane, provided that at least one R³ is hydrocarbyl having at least one functional group selected from hydroxyl, thiol, primary amine, secondary amine, oxirane. The hydrocarbyl groups from which R³ can each be independently selected, with some embodiments, are free of functional groups selected from hydroxyl, thiol, primary amine, secondary amine, oxirane, and thiooxirane.

With further reference to Formula (III), X² Independently for each v is a hydrolysable group, and the sum of u and v is 4, provided that u is at least 1 and v is at least 1. With some embodiments, and with further reference to Formula (III), u is 1 and v is 3. With some additional embodiments, and with further reference to Formula (III), u is 2, v is 2, one R³ is hydrocarbyl (that is free of functional groups), and the other R³ is hydrocarbyl having at least one functional group selected from hydroxyl, thiol, primary amine, secondary amine, oxirane, and thiooxirane.

With reference to Formula (III), the hydrocarbyl groups from which each R³ is independently selected include, but are not limited to, those classes and examples recited previously herein. With some embodiments, R³ independently for each u is selected from aryl, C₃-C₈ cycloalkyl, and linear or branched C₁-C₁₀ alkyl, which each independently have at least one functional group selected from hydroxyl, thiol, primary amine, secondary amine, oxirane, and thiooxirane. With some further embodiments, R³ independently for each u is selected from linear or branched C₁-C₆ alkyl, which each independently have at least one functional group selected from hydroxyl, thiol, primary amine, secondary amine, oxirane, and thiooxirane. The nonfunctional groups (or groups that are free of functional groups) from which each R³ can be independently selected, with some embodiments, include: aryl, C₃-C₈ cycloalkyl, and linear or branched C₁-C₂₀ alkyl; or linear or branched C₁-C₈ alkyl.

With further reference to Formula (III), X² independently for each v is as described previously herein with reference to X¹ of Formula (I). With some embodiments, X² independently for each v is represented by the following Formula (IIA),

—O—R²⁰ (IIA)

With reference to Formula (IIA), R²⁰ independently for each v is hydrocarbyl. With some embodiments, R²⁰ independently for each v is selected from aryl, C₃-C₈ cycloalkyl, and linear or branched C₁-C₂₀ alkyl. In accordance with some further embodiments, R²⁰ independently for each v is linear or branched C₁-C₆ alkyl.

Examples of functional hydrolysable silanes of the first composition, with some embodiments, include, but are not limited to: amino(linear or branched C₁-C₂₀ alkyl)trialkoxysilane, such as 3-aminopropyltrimethoxysilane and 3-aminopropyltriethoxysilane; (aminoalkyl)aminoalkyltrialkoxysilane, such as 3-(2-aminoethyl)aminopropyltrimethoxysilane and 3-(2-aminoethyl)aminopropyltriethoxysilane; (aminoalkyl)aminoalkyl-alkyl-dialkoxysilane, such as 3-(2-aminoethyl)aminopropyl-methyl-dimethoxysilane and 3-(2-aminoethyl)aminopropy-methyl-diethoxysilane; glycidoxy(linear or branched C₁-C₀ alkyl)trialkoxysilane, such as 3-glycdoxypropyltrimethoxysilane and 3-glycidoxypropyltriethoxysilane; thioglycidoxy(linear or branched C₁-C₂₀ alkyl)trialkoxysilane, such as 3-thioglyddoxypropyltrimethoxysilane and 3-thioglycidoxypropyltriethoxysilane; hydroxy(linear or branched C₁-C₂₀ alkyl)trialkoxysilane, such as 3-hydroxypropyltrimethoxysilane and 3-hydroxypropyltriethoxysilane; hydroxylalkyl-alkyl-dialkoxysilane, such as 3-hydroxypropyl-methyl-dimethoxysilane and 3-hydroxypropyl-methyl-diethoxysilane; thioalkyltrialkoxysilane, such as 3-thiopropyltrimethoxysilane and 3-thiopropyltriethoxysilane; thioxylalkyl-alkyl-dialkoxysilane, such as 3-thioxypropyl-methyl-dimethoxysilane and 3-thioxypropyl-methyl-diethoxysilane.

With some embodiments, the functional hydrolysable silane is present in the first composition in an amount of from 0.01 to 5 percent by weight, or from 0.01 to 4 percent by weight, or from 0.01 to 2 percent by weight, in which the percent weights in each case are based on total weight of the hydrolysable silane and the functional hydrolysable silane.

The fluorinated polyether modified silane of the second composition includes, with some embodiments: at least one fluorinated polyether segment represented by the following Formula (IV),

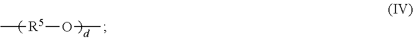

at least one silane group represented by the following Formula (V),

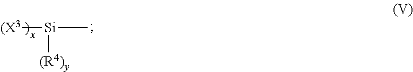

optionally at least one group represented by the following Formula (VI),

R⁶— (VI); and

optionally at least one divalent hydrocarbyl group optionally interrupted with at least one —O— group.

With reference to Formula (IV), R⁵ independently for each n is a fluorinated divalent hydrocarbyl group, and d is from 2 to 500, or from 2 to 400, or from 2 to 300, or from 2 to 200, or from 2 to 100, or from 20 to 75, or from 2 to 50, or from 2 to 25, or from 2 to 20, or from 2 to 15, or from 2 to 10. The fluorinated divalent hydrocarbyl group from which each R⁵ is independently selected, with some embodiments, is as defined previously herein. With some embodiments, the fluorinated divalent hydrocarbyl group from which each R⁵ is independently selected, is selected from: divalent linear or branched fluorinated C₁-C₂₅ alkyl (such as, divalent linear or branched fluorinated C₁-C₁₀ alkyl, or divalent linear or branched fluorinated C₁-C₆ alkyl); divalent fluorinated C₃-C₁₂ cycloalkyl (such as, divalent fluorinated C₃-C₁₀ cycloalkyl, or divalent fluorinated C₃-C₆ cycloalkyl); divalent fluorinated C₆-C₁₈ aryl (including divalent fluorinated polycyclic aryl groups) (such as, divalent fluorinated C₅-C₁₀ aryl).

With reference to the silane group represented by Formula (V): X³ independently for each x is a hydrolysable group; R⁴ independently for each y is hydrocarbyl; and the sum of x and y is 3, provided that x is at least 1. Each X³ of Formula (V) is independently as described previously herein with reference to X¹ of Formula (I). Each R⁴ of Formula (V) is independently as described previously herein with reference to R¹ of Formula (I).

With reference to Formula (VI), R⁶ is a perfluorohydrocarbyl group. The perfluorohydrocarbyl groups from which R⁶ can be selected, with some embodiments, are as defined previously herein. With some embodiments, examples of perfluorohydrocarbyl groups from which R⁶ can be selected include, but are not limited to: linear or branched perfluoro C₁-C₂₅ alkyl (such as, linear or branched perfluoro C₁-C₁₀ alkyl, or linear or branched perfluoro C₁-C₆ alkyl); perfluoro C₃-C₁₂ cycloalkyl (such as, perfluoro C₃-C₁₀ cycloalkyl, or perfluoro C₃-C₆ cycloalkyl); perfluoro C₅-C₁₆ aryl (including perfluoro polycyclic aryl groups) (such as, perfluoro C₅-C₁₀ aryl).

As described above, and with some embodiments, the fluorinated polyether modified silane of the second composition optionally includes at least one divalent hydrocarbyl group optionally interrupted with at least one —O— group. The divalent hydrocarbyl groups (optionally interrupted with at least one —O— group) can, with some embodiments, be selected from those classes and examples of hydrocarbyl groups described previously herein, which are further divalent. With some embodiments, examples of divalent hydrocarbyl groups (which can be optionally interrupted with at least one —O— group) include, but are not limited to: divalent linear or branched C₁-C₂₅ alkyl (such as, divalent linear or branched C₁-C₁₀ alkyl, or divalent linear or branched C₁-C₆ alkyl); divalent C₃-C₁₂ cycloalkyl (such as, divalent C₃-C₁₀ cycloalkyl, or divalent C₃-C₆ cycloalkyl); and divalent C₅-C₁₈ aryl (including divalent polycyclic aryl groups) (such as, divalent C₅-C₁₀ aryl).

The fluorinated polyether modified silane of the second composition is, with some embodiments, selected from at least one of, fluorinated polyether modified silane represented by the following Formula (VII), and/or fluorinated polyether modified silane represented by the following Formula (VIII): Formula (VII)

F—(CF₂)_{q}—(OC₃F₆)ₘ—(OC₂F₄)ₙ—(OCF₂)ₒ(CH₂)ₚX(CH₂)ᵣSi(X′)₃₋ₐ(R⁷)ₐ Formula (VII)

and

F—(CF₂)_{q}—(OC₃F₆)ₘ—(OC₂F₄)ₙ—(OCF₂)_{c}(CH₂)ₚX(CH₂)ᵣ(X′)₂₋ₐ(R⁷)ₐSiO(F—(CF₂)_{q})—(OC₃F₆)ₘ

(OC₂F₄)ₙ—(OCF₂)ₒ(CH₂)ₚX(CH₂)(X′)₁₋ₐ)(R⁷)ₐSiO)_{z}

F—(CF₂)—(OC₃F₆)ₘ(OC₂F₄)ₙ—(OCF₂)ₒ(CH₂)ₚX

(CH₂)ᵣ(X′)₂₋ₐ(R⁷)ₐSi. Formula (VIII)

The various groups (such as, but not limited to, X and X) and subscripts (such as, but not limited to, q, m, n, o, p, r, and a) that are the same as between Formulas (VII) and (VIII) are in each case independently selected from those groups and ranges as described in further detail herein.

With reference to Formula (VII), q is from 1 to 3; m, n, and o are each independently from 0 to 200 (or from 0 to 150, or from 0 to 100, or from 0 to 75, or from 0 to 50, or from 0 to 25, or from 0 to 20); p is 1 or 2; X is O (i.e., a divalent oxygen atom) or a divalent hydrocarbyl group; r is from 2-20 (or from 2 to 15, or from 2 to 10); R⁷ is a linear or branched C₁-C₂₅ alkyl group; a is from 0 to 2; and X′ is a hydrolysable group.

With reference to Formula (VIII), q is from 1 to 3; m, n, and o are each independently from 0 to 200 (or from 0 to 150, or from 0 to 100, or from 0 to 75, or from 0 to 50, or from 0 to 25, or from 0 to 20); p is 1 or 2; X is O (i.e., a divalent oxygen atom) or a divalent hydrocarbyl group; r is from 2-20 (or from 2 to 15, or from 2 to 10); R⁷ is a linear or branched C₁-C₂ alkyl group; a is from 0 to 2; X′ is a hydrolysable group; and z is from 0 to 10 (or from 0 to 8, or from 0 to 5), provided that a is 0 or 1.

The divalent hydrocarbyl groups from which X of Formula (VII) and Formula (VIII) can in each case be independently selected include, but are not limited to, those classes and examples as described previously herein. With some embodiments, the divalent hydrocarbyl groups from which X of Formula (VII) and Formula (VIII) can in each case be independently selected include, but are not limited to: divalent linear or branched C₁-C₂₅ alkyl (such as, divalent linear or branched C₁-C₁₀ alkyl, or divalent linear or branched C₁-C₆ alkyl); divalent C₃-C₁₂ cycloalkyl (such as, divalent C₃-C₁₀ cycloalkyl, or divalent C₃-C₆ cycloalkyl); and divalent C₅-C₁₈ aryl (including divalent polycyclic aryl groups) (such as, divalent C₅-C₁₀ aryl).

The hydrolysable groups X′ of Formula (VII) and (VIII) are each independently as described previously herein with reference to X¹ of Formula (I). With some embodiments, the hydrolysable groups X′ of Formula (VII) and (VIII) are each independently selected from hydrocarbyloxy groups, such as, but not limited to, aryloxy groups, C₃-C₈ cycloalkyloxy groups, and linear or branched C₁-C₂₀ alkyloxy groups. With some further embodiments, the hydrolysable groups X′ of Formula (VII) and (VIII) are each independently selected from methoxy, ethoxy, n-propyloxy, and i-propyloxy groups.

Fluorinated polyether modified silanes of the second composition as represented by Formulas (VII) and (VIII) are, with some embodiments, described in further detail in U.S. Pat. No. 8,211,544 at column 3, line 34 through column 5, line 63, which cited disclosure is incorporated herein by reference.

The fluorinated polyether modified silane of the second composition is, with some embodiments, selected from at least one fluorinated polyether modified silane represented by the following Formula (IX),

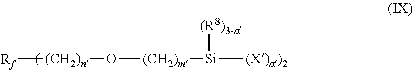

With reference to Formula (IX), R_{f} is a divalent straight-chain perfluoropolyether radical; each R⁸ independently is C₁ to C₄ alkyl or phenyl; each X′ independently is a hydrolysable group; each n′ independently is an integer from 0 to 2; each m′ independently is an integer from 1 to 5, and each a′ independently is 2 or 3.

The divalent straight-chain perfluoropolyether radicals from which R_{f} of Formula (IX) can be selected, in accordance with some embodiments, include at least one divalent group represented by the following Formula (XVI).

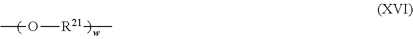

Subscript w of Formula (XVI), with some embodiments, is from 2 to 200 (or from 2 to 150, or from 2 to 100, or from 2 to 75, or from 2 to 50, or from 2 to 25, or from 2 to 20, or from 2 to 15, or from 2 to 10). With reference to Formula (XVI), R²¹ independently for each w is a divalent perfluorinated hydrocarbyl group. The hydrocarbyl of the divalent perfluorinated hydrocarbyl groups from which R²¹ can be selected include, but are not limited to, those classes and examples as described previously herein. With some embodiments, R²¹ is selected from: divalent linear or branched perfluoro C₁-C₂₅ alkyl (such as, divalent linear or branched perfluoro C₁-C₁₀ alkyl, or divalent linear or branched perfluoro C₁-C₈ alkyl); divalent perfluoro C₃-C₁₂ cycloalkyl (such as, divalent perfluoro C₃-C₁₀ cycloalkyl, or divalent perfluoro C₃-C₆ cycloalkyl); divalent perfluoro C₅-C₁₈ aryl (including divalent perfluoro polycyclic aryl groups) (such as, divalent perfluoro C₅-C₁₀ aryl). With some further embodiments, R²¹ independently for each w is selected from divalent perfluoro ethyl, divalent perfluoro n-propyl, divalent perfluoro i-propyl, divalent perfluoro n-butyl, divalent perfluoro i-butyl, and divalent perfluoro t-butyl.

The hydrolysable groups X′ of Formula (IX) are each independently as described previously herein with reference to X¹ of Formula (I). In accordance with some embodiments, each X′ of Formula (IX) is independently selected from hydrocarbyloxy groups, such as, but not limited to, aryloxy groups, C₃-C₈ cycloalkyloxy groups, and linear or branched C₁-C₂ alkyloxy groups. In accordance with some further embodiments, each X′ of Formula (IX) is Independently selected from methoxy, ethoxy, n-propyloxy, and i-propyloxy groups.

With further reference to Formula (IX), and in accordance with some embodiments, R_{f} is represented by the following Formula (X) or Formula (XI),

—CF₂CF₂O(CF₂CF₂CF₂O)ₖCF₂CF₂— Formula (X)

or

—CF₂(OC₂F₄)_{p′}(OCF₂)_{q′}— Formula (XI)

With reference to Formulas (X) and (XI), k, p′, and q′ are each independently at least 1, such as from 1 to 200 (or from 1 to 150, or from 1 to 100, or from 1 to 75, or from 1 to 50, or from 1 to 25, or from 1 to 20, or from 1 to 15, or from 1 to 10, or from 1 to 5).

Fluorinated polyether modified silanes of the second composition as represented by Formula (IX) are, with some embodiments, described in further detail in U.S. Pat. No. 7,196,212 B2 at column 5, line 40 through column 10, line 24, which cited disclosure is incorporated herein by reference.

In accordance with some embodiments, the fluorinated polyether modified silane of the second composition is selected from at least one fluorinated polyether modified silane represented by the following Formula (XII).

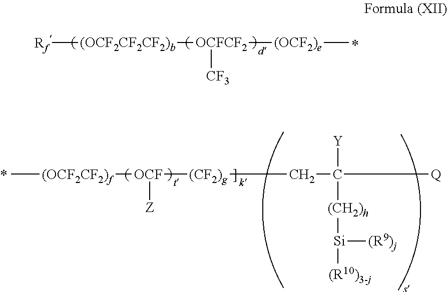

With reference to Formula (XII): R_{f}′ is perfluoroalkyl; Z is fluoro or trifluoromethyl; b, d′, e, f, and g are each independently for each k′, 0 or at least 1 (such as from 1 to 200, or from 1 to 150, or from 1 to 100, or from 1 to 75, or from 1 to 50, or from 1 to 25, or from 1 to 20, or from 1 to 15, or from 1 to 10, or from 1 to 5), provided that the sum of b+d′+e+f+g is at least 1 for each k′; t′ is 0 or 1, provided that t′ is 1 for only one k′; k′ is at least 1 (such as from 1 to 200, or from 1 to 150, or from 1 to 100, or from 1 to 75, or from 1 to 50, or from 1 to 25, or from 1 to 20, or from 1 to 15, or from 1 to 10, or from 1 to 5); Y is hydrogen or a C₁-C₄ alkyl group; Q is hydrogen, bromo or iodo; R⁹ is hydroxy or a hydrolysable group; R¹⁰ is hydrogen or a hydrocarbyl group; h is 0, 1 or 2; j is 1, 2 or 3; and s′ is at least 2 (such as from 2 to 200, or from 2 to 150, or from 2 to 100, or from 2 to 75, or from 2 to 50, or from 2 to 25, or from 2 to 20, or from 2 to 15, or from 2 to 10, or from 2 to 5).

With some embodiments, R_{f}′ of Formula (XII) is selected from: linear or branched perfluoro C₁-C₂₅ alkyl, such as, linear or branched perfluoro C₁-C₁₀ alkyl, or linear or branched perfluoro C₁-C₆ alkyl. In accordance with some further embodiments, R_{f}′ is selected from perfluoro ethyl, perfluoro n-propyl, perfluoro i-propyl, perfluoro n-butyl, perfluoro i-butyl, and perfluoro t-butyl.

The hydrocarbyl groups from which each R¹⁰ of Formula (XII) can be independently selected, with some embodiments, include, but are not limited to, those classes and examples of hydrocarbyl groups as described previously herein. With some further embodiments, each R¹⁰ of Formula (XII) is independently selected from: linear or branched C₁-C₂₅ alkyl (such as, linear or branched C₁-C₁₀ alkyl, or linear or branched C₁-C₆ alkyl); C₃-C₁₂ cycloalkyl (such as, C₃-C₁₀ cycloalkyl, or C₃-C₆ cycloalkyl); and C₅-C₁₈ aryl (including polycyclic aryl groups) (such as, C₅-C₁₀ aryl). With some additional embodiments, each R¹⁰ of Formula (XII) is independently selected from: methyl; ethyl; n-propyl; i-propyl; n-butyl; i-butyl; and t-butyl.

The hydrolysable groups from which R⁹ of Formula (XII) can be selected, with some embodiments, include those as described previously herein with reference to the hydrolysable group X¹ of Formula (I). With some further embodiments, the hydrolysable groups from which each R⁹ of Formula (XII) can be independently selected, are hydrocarbyloxy groups, such as, but not limited to, aryloxy groups, C₃-C₈ cycloalkyloxy groups, and linear or branched C₁-C₂₀ alkyloxy groups. In accordance with some further embodiments, the hydrolysable groups from which each R⁹ of Formula (XII) can be independently selected, include, but are not limited to, methoxy, ethoxy, n-propyloxy, and i-propyloxy groups.

Fluorinated polyether modified silanes of the second composition as represented by Formula (XII) are, with some embodiments, described in further detail in U.S. Pat. No. 6,183,872 B1 at column 5, line 35 through column 15, line 14, which cited disclosure is incorporated herein by reference.

The fluorinated polyether modified silane is present in the second composition of the method of the present invention in any suitable amount. With some embodiments, the fluorinated polyether modified silane is present in the second composition of the method of the present invention in an amount of at least 0.01 percent by weight, or at least 2 percent by weight: and less than or equal to 5 percent by weight, or less than or equal to 4 percent by weight, the percent weights being based on total weight of the second composition. The fluorinated polyether modified silane can be present in the second composition in an amount ranging between any combination of these upper and lower values, inclusive of the cited values, such as from 0.01 to 5 percent by weight, or from 2 to 4 percent by weight, based on total weight of the second composition, with some embodiments.

The second composition of the method of the present invention, with some embodiments, includes a solvent, such as an organic solvent, such as a fluorinated solvent. Examples of organic solvents that can be included in the second composition include, but are not limited to those classes and examples of organic solvents described previously herein with regard to the first composition, with some embodiments. The fluorinated solvent of the second composition includes at least one of, fluorinated hydrocarbons and/or hydrofluoroethers, with some embodiments. When the second composition includes a solvent, such as a fluorinated solvent, the fluorinated polyether modified silane is present in an amount of from 0.01 to 5 percent by weight, based on total weight of the second composition, with some embodiments.

The solvent, such as the fluorinated solvent, can be present in the second composition, with some embodiments in an amount of at least 95 percent by weight, or at least 96 percent by weight; and less than or equal to 99.99 percent by weight, or less than or equal to 98 percent by weight, the percent weights being based on total weight of the second composition. The solvent, such as the fluorinated solvent, can be present in the second composition in an amount ranging between any combination of these upper and lower values, inclusive of the cited values, such as from 95 to 99.99 percent by weight, or from 96 to 98 percent by weight, based on total weight of the second composition, with some embodiments.

Fluorinated hydrocarbons that can be present in the second composition, with some embodiments, include, but are not limited to, linear or branched fluorinated C₁-C₂₅ alkanes (such as, linear or branched fluorinated C₁-C₁₀ alkanes, or linear or branched fluorinated C₁-C₆ alkanes); fluorinated C₃-C₁₂ cycloalkanes (such as, fluorinated C₃-C₁₀ cycloalkanes, or fluorinated C₃-C₆ cycloalkanes); and fluorinated C₅-C₁₈ aromatic compounds (including fluorinated polycyclic aromatic compounds) (such as, fluorinated C₅-C₁₀ aromatic compounds). As used herein, the term “fluorinated hydrocarbons” means: hydrocarbons in which at least some and up to all available hydrogens have been replaced with fluorine atoms, including hydrofluorohydrocarbons (or hydrofluorinated hydrocarbons), perfluorohydrocarbons (or perfluorinated hydrocarbons), and combinations thereof.

Hydrofluoroethers that can, with some embodiments, be present in the second composition, are ethers in which less than all available hydrogens have been replaced with fluorine atoms. With some embodiments, the hydrofluoroethers are selected from hydrofluorinatedhydrocarbyl-hydrofluorinatedhydrocarbyl ethers, perfluorinatedhydrocarbyl-hydrocarbyl ethers (which are referred to as segregated hydrofluoroethers), and combinations thereof. The hydrocarbyl groups of the hydrofluoroethers include, but are not limited to, those classes and examples as described previously herein. In accordance with some embodiments, the hydrofluoroethers include, but are not limited to, hydrofluorinated linear or branched C₁-C₂₅ alkane-hydrofluorinated linear or branched C₁-C₂₅ alkane ethers, perfluorinated linear or branched C₁-C₂₅ alkane-linear or branched C₁-C₂₅ alkane ethers, and combinations thereof. Examples of commercially available hydrofluoroethers that can be present in the second composition, with some embodiments, include, but are not limited to, NOVEC HFE 7100 (which is described as included C₄F₉—O—CH₃) and NOVEC HFE 7200 (which is described as containing C₄F₉—OC₂H₅), which are commercially available from 3M Company.

The second composition, with some embodiments, further includes a protonic acid. The protonic acid, with some embodiments, acts as a catalyst, which catalyzes condensation of the hydrolysable groups of the fluorinated polyether modified silane.

The protonic acid of the second composition includes, with some embodiments, at least one of, carboxylic acid, hydrogen halide, sulphuric acid, and/or nitric acid. The protonic acids of the second composition are each independently as described previously herein with regard to the protonic acids of the first composition. Carboxylic acids from which the protonic acid of the second composition can be selected, with some embodiments, include, but are not limited to, hydrocarbyl groups having at least one carboxylic acid group, in which the hydrocarbyl group is selected from those classes and examples recited previously herein. Examples of carboxylic acids, from which the protonic acid of the second composition can be selected, with some embodiments, include, but are not limited to, linear or branched C₁-C₆ carboxylic acids, such as acetic acid. Examples of hydrogen halides from which the protonic acid of the second composition can be selected from include, but are not limited to, HCl, HF, HBr, and/or HI.

The protonic acid can, with some embodiments, be present in the second composition in an amount of from 0.01 to 10 percent by weight, based on the total weight of said second composition.

In accordance with some embodiments, the intermediate coated glass substrate is subjected to elevated temperature of from 40° C. to 300° C. for 5 minutes to 8 hours. Subjecting the intermediate coated glass substrate to elevated temperature results in, with some embodiments: (i) curing of the applied second composition; or (ii) concurrent curing of both the underlying and previously applied first composition, and the overlying and subsequently applied second composition.

The first composition and the second composition are, with some embodiments, each applied at ambient temperature. With some embodiments application of each of the first and second compositions at ambient temperature is believed to result in minimal or no curing of the first and second compositions during each application process. With some embodiments, applying the first composition and applying the second composition are each independently conducted at a temperature of 15° C. to less than 40° C., or from 18° C. to 30° C., or from 20° C. to 28° C., or from 24° C. to 26° C.

The method of the present invention, with some embodiments, is free of subjecting the treated surface of the glass substrate to elevated temperature prior to application of the second composition to the treated surface. While not intending to be bound by any theory, it is believed that conducting the method of the present invention such that it is free of subjecting the treated surface of the glass substrate to elevated temperature prior to application of the second composition to the treated surface, results in minimal to no curing of the previously applied first composition prior to the subsequent application of the second composition thereover. With some embodiments, the treated surface of the glass substrate is free of being subjected to temperatures of 40° C. or greater, or 35° C. or greater, or 30° C. or greater, or 27° C. or greater, or 25° C. or greater.

With the method of the present invention and in accordance with some embodiments, when the method is free of subjecting the treated surface of the glass substrate to elevated temperature prior to application of the second composition to the treated surface, subjecting the intermediate coated glass substrate to elevated temperature (such as 40° C. to 300° C. for 5 minutes to 8 hours) is believed to result in the concurrent curing of both the underlying and previously applied first composition, and the overlying and subsequently applied second composition.

The first and second compositions can each be independently applied by one or more art-recognized methods, with some embodiments. With some further embodiments, the first and second compositions can each be independently applied by wet coating methods and/or dry coating methods. Examples of wet coating methods include, but are not limited to, spray coating, spin coating, dip coating, flow coating, and roll coating. Examples of dry coating methods include, but are not limited to: physical vapor deposition methods, such as vacuum evaporation, reactive deposition, ion beam assisted deposition, sputtering, and Ion plating; and chemical vapor deposition methods. With some embodiments, the first and second compositions are each independently applied by wet coating methods, and are free of application by dry coating methods.

The present invention also relates to a coated glass substrate that is formed by the method of the present invention as described previously herein, which includes: (a) applying a first composition that includes a hydrolysable silane to a surface of a glass substrate, thereby forming a treated surface of the glass substrate, in which the hydrolysable silane is represented by Formula (I) as described previously herein; (b) applying to the treated surface a second composition that includes a fluorinated polyether modified silane as described previously herein, thereby forming an Intermediate coated glass substrate; and (c) subjecting the intermediate coated glass substrate to elevated temperature, thereby curing the second composition (or concurrently curing the first composition and the second composition) and forming the coated glass substrate.

The method of the present invention results in the formation of coated glass substrates that, with some embodiments, have anti-fouling properties. With some further embodiments, the method of the present invention results in the formation of coated glass substrates that are resistant to the pick-up of dirt and/or the pick-up of oils, such as oils on and/or produced by human skin, such as oils on and/or produced by the skin of human fingertips. Examples of coated glass substrates according to and which can be prepared by the method of the present invention include, but are not limited to: touch screens, such as smart-phone touch screens, computer tablet touch screens, and user interface and/or process control touch screens; glass transparencies, such as motor vehicle transparencies, aircraft transparencies, architectural transparencies, and welding transparencies, such as transparencies used in welding helmets; and eyeglasses, such as sunglasses, ophthalmic glass lenses, and photochromic ophthalmic glass lenses.

The present invention is more particularly described in the following examples, which are intended to be illustrative only, since numerous modifications and variations therein will be apparent to those skilled in the art. Unless otherwise specified, all parts and percentages are by weight.

### EXAMPLES

### Coating Compostions

Coating Compositions A-E were prepared in accordance with the following descriptions. Glass test specimens were coated with the Coating Compositions and evaluated, as described in further detail below.

### Coating Composition A

Coating Composition A was prepared by mixing, in a suitable container, (a) KY-108 perfluorpolyether solution (obtained commercially from Shin-Etsu Chemical Co., Ltd.) with (b) HFE-7100 3M NOVEC Engineered Fluid (obtained commercially from 3M Company, which is described as a mixture of methyl nonafluoroisobutyl ether and methyl nonfluorobutyl ether). The amounts of components (a) and (b) were selected such that the coating composition contained 0.2 percent by weight of component (a) based on total weight of components (a) and (b).

### Coating Composition B

Coating Composition B was prepared in accordance with the description provided for Coating Composition A, but component (a) was KY-164 organosilicon compound solution, which was obtained commercially from Shin-Etsu Chemical Co., Ltd.

### Coating Composition C

Coating Composition C was prepared in accordance with the description provided for Coating Composition A, but component (a) was DOW CORNING 2634 alkoxysilane, which was obtained commercially from Dow Corning Corporation, which is described as heptafluoropropoxy(poly(perfluoroPO))tetrafluoropropyloxypropyltrimethoxysilane in solvent.

### Coating Composition D

Coating Composition D was prepared in accordance with the description provided for Coating Composition A, but component (a) was OPTOOL DSX fluoro-compound, which was obtained commercially from Dalkin Industries, Ltd.

### Coating Composition E

Tetraethoxysilane (TEOS) (obtained commercially from Momentive Performance Materials) was mixed in a suitable container with ethanol (containing 10 to 100 ppm of nitric add), such that the resulting coating composition contained TEOS in an amount of 0.1 percent by weight based on total weight of TEOS and ethanol.

### Preparation and Evaluation of Glass Test Specimens

Each coating layer was formed by spin-coating approximately 2.2 grams of the identified coating composition at a spin rate of 1100 revolutions per minute for 10 seconds on GORILLA GLASS specimens having dimensions of 10.5 cm by 5.5 cm. Baking of each layer, or combination of layers, was conducted at 200° C. for 10 minutes in a Despatch LFD series electric oven.

Prior to coating, the GORILLA GLASS specimens were cleaned by wiping with isopropanol using KIMTECH SCIENCE Large Precision Wipes.

Each of Coating Compositions A-D were evaluated using three different coating processes, which are described as follows.

### Coating Process (1)

The Coating Composition (A, B, C, or D, as the case may be) was applied directly to an uncoated GORILLA GLASS specimen and baked at 200° C. for 10 minutes. This is referred to as a “direct-to-glass” coating process, which correspondingly resulted in the formation of direct-to-glass test specimens.

### Coating Process (2)

Coating Composition E was first applied to an uncoated GORILLA GLASS specimen and baked at 200° C. for 10 minutes. The coated intermediate test specimen was allowed to cool to room temperature, and then a Coating Composition (A, B, C, or D, as the case may be) was applied over the dried TEOS layer, which was baked at 200° C. for 10 minutes. This is referred to as a wet-on-dry coating process, which correspondingly resulted in the formation of wet-on-dry test specimens.

### Coating Process (3)

Coating Composition E was first applied to an uncoated GORILLA GLASS specimen, and then (without an intermediate bake cycle) a Coating Composition (A, B, C, or D, as the case may be) was applied over the wet TEOS layer. The coated test specimen was then subjected to a single bake at 200° C. for 10 minutes. This is referred to as a wet-on-wet coating process, which correspondingly resulted in the formation of wet-on-wet test specimens.

### Abrasion Testing

The coated test specimens were subjected to steel wool abrasion testing using a Taber linear abrader model number 5750. A fresh piece of 0000 steel wool was used for each test specimen and replaced at each interval. Taber test parameters were: a linear travel length of 2 inches (5.1 cm); 40 cycles/minute; and total rod assembly weight of 998 grams. All coated test specimens were subjected to abrasion testing on the same day under ambient conditions of 48% relative humidity and a temperature of 76° F. (24.4° C.).

### Contact Angle

Contact angle measurements were performed on the test specimens prior to abrasion testing, after 1000 cycles of abrasion testing, and after 2000 cycles of abrasion testing. Contact angle measurements were obtained using a Kruss DSA 100 drop shape analyzer along with the DSA1 version1.90.0.14 software. A 2 microliter (μl) drop of HPLC grade water (obtained from Fisher Scientific or Aldrich) was applied, in each case, to a separate area on the test specimen, and a minimum of 3 test drops were measured and averaged in each case. The drop contact angles were measured via the Tangent Method 2 Routine in the software that fits the profile of the sessile drop. (References: Kruss DSA1 v1.9-03 software user manual, Kruss DSA100 v1-06 operation manual). The contact angle test results are summarized in the following Table 1.

TABLE 1

| Coating | Coating | | CA° after 1000 | CA° after 2000 |
|---|---|---|---|---|
| Composition | Process | Initial CA°¹ | cycles² | cycles³ |
| A | (1) | 107.4 | 40.4 | ND⁴ |
| | (2) | 108.6 | 69.8 | ND |
| | (3) | 108.6 | 62.7 | ND |
| B | (1) | 105.1 | 37.6 | ND |
| | (2) | 106.1 | 82.0 | ND |
| | (3) | 105.9 | 77.8 | ND |
| C | (1) | 110.0 | 96.4 | ND |
| | (2) | 113.1 | 109.1 | 105.3 |
| | (3) | 113.3 | 107.7 | 105.5 |
| D | (1) | 110.4 | 80.2 | ND |
| | (2) | 112.7 | 69.9 | ND |
| | (3) | 114.1 | 97.0 | ND |

¹Initial Contact Angle.
²Contact angle after 1000 cycles of linear Taber abrasion testing.
³Contact angle after 2000 cycles of linear Taber abrasion testing.
⁴ND means that a contact angle could not be measured.

In the above Table 1, higher contact angles are preferred, because they are typically associated with improved properties, such as dirt and/or smudge resistance.

Test specimens prepared in accordance with Coating Process (3), which is a non-limiting embodiment of the process of the present invention, provided: higher initial and 1000 abrasion cycle contact angles, compared to the direct-to-glass test specimens, which were prepared using Coating Process (1). Test specimens prepared in accordance with Coating Process (3) provided: similar initial contact angles, and similar or higher 1000 abrasion cycle and 2000 abrasion cycle contact angles, compared to the dry-on-dry test specimens, which were prepared using Coating Process (2).

The present invention has been described with reference to specific details of particular embodiments thereof. It is not intended that such details be regarded as limitations upon the scope of the invention except insofar as and to the extent that they are included in the accompanying claims.

What is claimed is:

1. A method of forming a coated glass substrate comprising:
(a) applying a first composition comprising a hydrolysable silane to a surface of a glass substrate, thereby forming a treated surface of said glass substrate, wherein said hydrolysable silane is represented by the following Formula (I), 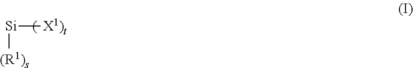
wherein,
R¹ independently for each s is hydrocarbyl,
X¹ independently for each t is a hydrolysable group, and
the sum of s and t is 4, provided that t is at least 1;
(b) applying to said treated surface a second composition comprising a fluorinated polyether modified silane, thereby forming an intermediate coated glass substrate; and
(c) subjecting said intermediate coated glass substrate to elevated temperature, thereby curing said second composition and forming said coated glass substrate.

2. The method of claim 1 wherein X¹ of Formula (I) is represented by the following Formula (II),
—O—R² (II)
wherein R² independently for each t is hydrocarbyl.

3. The method of claim 2 wherein,
R¹ independently for each s is selected from aryl, C₃-C₈ cycloalkyl, and linear or branched C₁-C₂₀ alkyl, and
R² independently for each t is selected from aryl, C₃-C₈ cycloalkyl, and linear or branched C₁-C₂₀ alkyl.

4. The method of claim 3 wherein,
R¹ independently for each s is linear or branched C₁-C₆ alkyl,
R² independently for each t is linear or branched C₁-C₆ alkyl, and
the sum of s and t is 4, provided that t is at least 3.

5. The method of claim 4 wherein for Formula (I), t is 4.

6. The method of claim 1 wherein said first composition further comprises an organic solvent.

7. The method of claim 6 wherein said organic solvent comprises at least one of, linear or branched alkanes, cycloalkanes, aromatic compounds, alcohols, ethers, aldehydes, ketones, and carboxylic acid esters.

8. The method of claim 7 wherein said organic solvent comprises at least one linear or branched C₁-C₆ alcohol.

9. The method of claim 6 wherein said hydrolysable silane is present in said first composition in an amount of from 0.01 to 5 percent by weight, based on total weight of said first composition.

10. The method of claim 6 wherein said first composition further comprises a protonic acid.

11. The method of claim 10 wherein said protonic acid comprises at least one of carboxylic acid, hydrogen halide, sulphuric acid, and nitric acid.

12. The method of claim 11 wherein said protonic acid is present in an amount of from 0.01 to 5 parts by weight per 100 parts by weight of said hydrolysable silane.

13. The method of claim 1 wherein said first composition further comprises a functional hydrolysable silane represented by the following Formula (III),
wherein, 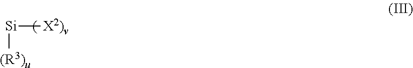
R³ independently for each u is selected from hydrocarbyl, and hydrocarbyl having at least one functional group selected from hydroxyl, thiol, primary amine, secondary amine, oxirane, and thiooxirane, provided that at least one R³ is hydrocarbyl having at least one functional group selected from hydroxyl, thiol, primary amine, secondary amine, oxirane, and thiooxirane,
X² independently for each v is a hydrolysable group, and
the sum of u and v is 4, provided that u is at least 1 and v is at least 1.

14. The method of claim 1 wherein said fluorinated polyether modified silane of said second composition comprises:
at least one fluorinated polyether segment represented by the following Formula (IV), 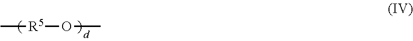
wherein R⁵ independently for each n is a fluorinated divalent hydrocarbyl group, and
d is from 2 to 500;
at least one silane group represented by the following Formula (V), 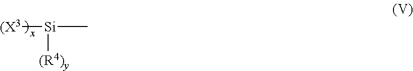
wherein,
X³ independently for each x is a hydrolysable group,
R⁴ independently for each y is hydrocarbyl, and
the sum of x and y is 3, provided that x is at least 1;
optionally at least one group represented by the following Formula (VI),
R⁶— (VI)
wherein R⁶ is a perfluorohydrocarbyl group; and
optionally at least one divalent hydrocarbyl group optionally interrupted with at least one —O— group.

15. The method of claim 1 wherein said fluorinated polyether modified silane of said second composition is selected from at least one of, fluorinated polyether modified silane represented by the following Formula (VII) and fluorinated polyether modified silane represented by the following Formula (VIII),
F—(CF₂)_{q}—(OC₃F₆)ₘ—(OC₂F₄)ₙ—(OCF₂)ₒ(CH₂)ₚX(CH₂)ᵣSi(X′)₃₋ₐ(R⁷)ₐ Formula (VII)
and
F—(CF₂)_{q}—(OC₃F₆)ₘ—(OC₂F₄)ₙ—(OCF₂)_{c}(CH₂)ₚX(CH₂)ᵣ(X′)₂₋ₐ(R⁷)ₐSiO(F—(CF₂)_{q})—(OC₃F₆)ₘ
(OC₂F₄)ₙ—(OCF₂)ₒ(CH₂)ₚX(CH₂)(X′)₁₋ₐ)(R⁷)ₐSiO)_{z}
F—(CF₂)—(OC₃F₆)ₘ(OC₂F₄)ₙ—(OCF₂)ₒ(CH₂)ₚX
(CH₂)ᵣ(X′)₂₋ₐ(R⁷)ₐSi. Formula (VIII)
wherein for Formula (VII),
q is from 1 to 3; m, n, and o are each independently from 0 to 200; p is 1 or 2; X is O or a divalent hydrocarbyl group; r is from 2-20; R⁷ is a linear or branched C₁-C₂₅ alkyl group; a is from 0 to 2; and X′ is a hydrolysable group,
wherein for Formula (VIII),
q is from 1 to 3; m, n, and o are each independently from 0 to 200; p is 1 or 2; X is O or a divalent hydrocarbyl group; r is from 2-20; R⁷ is a linear or branched C₁-C₅ alkyl group; a is from 0 to 2; X′ is a hydrolysable group; and z is from 0 to 10, provided that a is 0 or 1.

16. The method of claim 1 wherein said fluorinated polyether modified silane of said second composition is selected from at least one fluorinated polyether modified silane represented by the following Formula (IX), 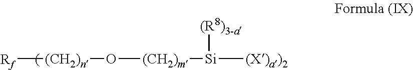
wherein for Formula (IX),
R_{f} is a divalent straight-chain perfluoropolyether radical; each R⁸ independently is C₁ to C₄ alkyl or phenyl; each X′ independently is a hydrolysable group; each n′ independently is an integer from 0 to 2; each m′ independently is an integer from 1 to 5, and each a′ independently is 2 or 3.

17. The method of claim 16 wherein R of Formula (IX) is represented by the following Formula (X) or Formula (XI),
—CF₂CF₂O(CF₂CF₂CF₂O)ₖCF₂CF₂— Formula (X)
or
—CF₂(OC₂F₄)_{p′}(OCF₂)_{q′}— Formula (XI)
wherein k, p′, and q′ are each independently at least 1.

18. The method of claim 1 wherein said fluorinated polyether modified silane of said second composition is selected from at least one fluorinated polyether modified silane represented by the following Formula (XII), 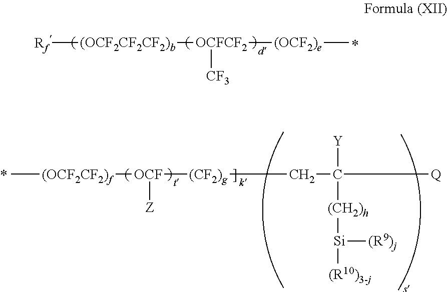
wherein for Formula (XII),
R_{f}′ is perfluoroalkyl; Z is fluoro or trifluoromethyl; b, d′, e, f, and g are each independently for each k′0 or at least 1, provided that the sum of b+d′+e+f+g is at least 1 for each k′; t′ is 0 or 1, provided that t′ is 1 for only one k′; k′ is at least 1; Y is hydrogen or a C₁-C₄ alkyl group; Q is hydrogen, bromo or iodo; R⁹ is hydroxy or a hydrolysable group; R¹⁰ is hydrogen or a hydrocarbyl group; h is 0, 1 or 2; j is 1, 2 or 3; and s′ is at least 2.

19. The method of claim 1 wherein,
said second composition comprises a fluorinated solvent, wherein said fluorinated solvent comprises at least one of fluorinated hydrocarbons and hydrofluoroethers, and
said fluorinated polyether modified silane is present in an amount of from 0.01 to 5 percent by weight, based on total weight of said second composition.

20. The method of claim 19 wherein,
said second composition further comprises a protonic acid, wherein said protonic acid comprises at least one of carboxylic acid, hydrogen halide, sulphuric acid, and nitric add, and
said protonic acid is present in an amount of from 0.01 to 10 percent by weight, based on the total weight of said second composition.

21. The method of claim 1 wherein said intermediate coated glass substrate is subjected to elevated temperature of from 40° C. to 300° C. for 5 minutes to 8 hours.

22. The method of claim 21 wherein applying said first composition and applying said second composition are each independently conducted at a temperature of 15° C. to less than 40° C.

23. The method of claim 21 wherein said method is free of subjecting said treated surface of said glass substrate to elevated temperature prior to application of said second composition to said treated surface.

24. A coated glass substrate formed by a method comprising:
(a) applying a first composition comprising a hydrolysable silane to a surface of a glass substrate, thereby forming a treated surface of said glass substrate, wherein said hydrolysable silane is represented by the following Formula (I), 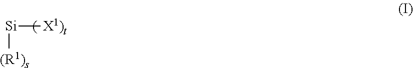
wherein,
R¹ independently for each s is hydrocarbyl,
X¹ independently for each t is a hydrolysable group, and
the sum of s and t is 4, provided that t is at least 1;
(b) applying to said treated surface a second composition comprising a fluorinated polyether modified silane, thereby forming an intermediate coated glass substrate; and
(c) subjecting said intermediate coated glass substrate to elevated temperature, thereby curing said second composition and forming said coated glass substrate.
